(19) United States
(12) Patent Application Publication
(10) Pub. No.: US 2002/0108971 A1
(43) Pub. Date: Aug. 15, 2002

(54) Motor operated caulking gun

(76) Inventor: Luc Lafond, Etobicoke (CA)

Correspondence Address: DENNISON ASSOCIATES, Suite 301, 133 Richmond Street West, Toronto, ON, M5H 2L7, CA

(21) Appl. No.: 09/780,464

(22) Filed: Feb. 12, 2001

(51) Int. Cl. G01F 11/00

(52) U.S. Cl. 222/333

(57) ABSTRACT

A caulking cartridge dispensing assembly includes a rigid frame having a cartridge holder with a slotted opening axially of the holder. Contained within the rigid frame is an electrically operated drive member which extends lengthwise of the frame aligned with the slotted opening of the cartridge holder. Also provided are a plunger and a drive member transfer member which fits through the slotted opening between the drive member and the plunger. The drive member transfer member is adjustable between a drive member engaged condition and a drive member released condition. The plunger is connected with the drive member and moveable along the frame by the drive member when the drive member transfer member is in the engaged condition and the plunger is slideable relative to both the drive member and the rigid frame when the drive transfer member is in the released condition.

### FIELD OF THE INVENTION

The present invention relates to an electrically operated caulking cartridge dispensing assembly.

### BACKGROUND OF THE INVENTION

A typical caulking gun is one which includes a lever which is operated by hand pressure to move a plunger forwardly against a caulking cartridge or tube held within the gun.

The amount of hand pressure required to produce a smooth, even flow of caulking material is not easy to control in the gun described above. Typically, too much pressure is used resulting in an excessive amount of caulking material flowing from the cartridge.

There are now available, electrically operated caulking guns. These guns can be used with better control than the more widely known manually operated guns. Typically these guns comprise hand controls which attach to the rear of the caulking tube and push forwardly from the back of the tube. This produces an unbalanced construction which is awkward and heavy to hold over a prolonged period of time.

One example of an electrically operated caulking gun which has a more centred hand control is described in U.S. Pat. No. 5,503,307 issued Apr. 2, 1996 to Wilson et Al. The caulking gun in this patent again includes an electrically operated plunger which pushes on the caulking tube to dispense material from the gun.

In the Wilson construction, the plunger drive In the Wilson construction, the plunger drive which is in the form of an electrical motor having rotating gears engaged with a fixed gear, is actually part of and adds to the weight of the plunger. This results in a gun which is awkward to handle because the balance point of the gun changes significantly as the plunger moves over the length of the gun.

### SUMMARY OF THE PRESENT INVENTION

The present invention relates to a caulking cartridge dispensing assembly which is electrically operated for maximizing control of the assembly and which is further easily manipulated by a person using the assembly. In addition, the assembly is designed to efficiently dispense material from a standard caulking cartridge.

More specifically, the caulking cartridge dispensing assembly of the present invention comprises a rigid frame having a cartridge holder with a slotted opening axially of the cartridge holder. Contained within the rigid frame is an electrically operated drive member extending lengthwise of the frame aligned with the slotted opening of the cartridge holder. Further provided are a plunger and a drive transfer member which fits through the slotted opening between the drive member and the plunger. The drive transfer member is adjustable between a drive member engaged condition and a drive member released condition.

The plunger is connected with and moveable along the frame by the drive member when the drive transfer member is in the engaged condition for dispensing material from the cartridge.

The plunger is slideable relative to both the drive member and the rigid frame when the drive transfer member is in the released condition allowing the plunger to be moved for replacing a used cartridge with a new cartridge or for simply releasing the pressure of the plunger on the cartridge.

### BRIEF DESCRIPTION OF THE DRAWINGS

The above as well as other advantages and features of the present invention will be described in greater detail according to the preferred embodiments of the present invention in which;

FIG. 1 is an exploded perspective view of a caulking system using a caulking gun assembly according to a preferred embodiment of the present invention.

FIG. 2 is a sectional view of the assembled system of FIG. 1.

FIG. 3 is an enlarged perspective view of the plunger and part of the drive system for the plunger from the caulking gun assembly of FIG. 1.

FIG. 4 is a perspective view of the rear end of the caulking cartridge of the system of FIG. 2.

FIG. 5 is an exploded perspective view of the tube cutter from the plunger of FIG. 3.

FIG. 6 is a sectional view through the caulking cartridge of FIG. 1 as it is cut and deflected using the cutting member of FIG. 5.

FIGS. 7 through 9 are side views of different cutting members which according to preferred embodiments of the present invention are usable in replacement of the cutting member shown in FIG. 5.

FIGS. 10 through 12 are sectional views through cartridges showing different cutting and cartridge deflecting positions according to different preferred embodiments of the present invention.

FIG. 13 is an enlarged perspective view of a plunger incorporating a different cartridge cutter according to yet another preferred embodiment of the present invention.

FIG. 14 is a sectional view of a cartridge after it has been cut using the plunger and cutter of FIG. 13.

FIG. 15 is a sectional view through a caulking gun system according to another preferred embodiment of the present invention.

FIG. 16 is an enlarged perspective view of the plunger and part of the drive system for the plunger from the assembly of FIG. 15.

FIG. 17 is an exploded perspective view of an operating assembly usable with the gun of FIG. 15 according to a preferred feature of the invention.

FIG. 18 shows the assembly of FIG. 17 when fitted with the gun of FIG. 15.

FIG. 19 is a sectional view of a caulking gun similar to the gun of FIG. 15 including yet a further feature of the invention.

FIG. 20 is a side view of a caulking gun assembly according to another embodiment of the invention.

FIG. 21 is a sectional view along the lines A-A of FIG. 20.

FIG. 22 is an exploded perspective view of a caulking gun system according to a further preferred embodiment of the invention.

FIG. 23 is a sectional view along the lines B-B of FIG. 22.

### DETAILED DESCRIPTION ACCORDING TO THE PREFERRED EMBODIMENTS OF THE PRESENT INVENTION

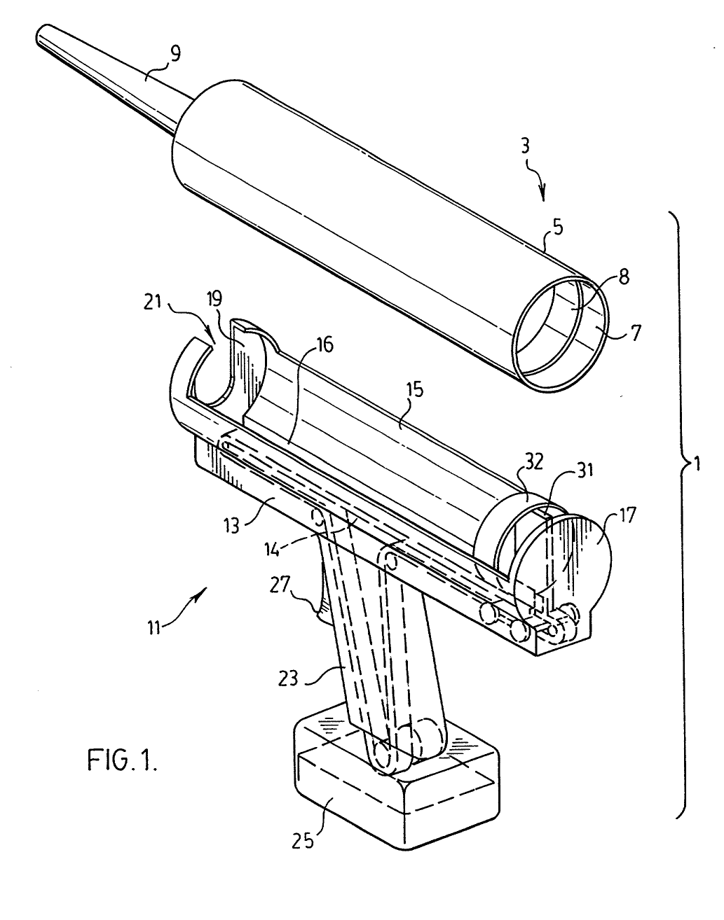

FIG. 1 shows an overall caulking gun system generally indicated at 1. This system comprises a standard caulking cartridge generally indicated at 3 and a gun-like cartridge dispensing assembly generally indicated at 11.

The caulking cartridge 3 has a main caulking material containing body 5 which is open at its rear end 7 and having a front nozzle 9. A slideable cap 8 which holds the caulking material within the main body of the cartridge is exposed through the open end 7 of the cartridge.

Referring now to FIGS. 1 and 2, the gun assembly 11 is formed from a main rigid frame 13 provided at its upper end with a cartridge holder 15 and a handle 23 at the under side of the main frame. Handle 23 has a bottom end motor housing 25. An operating trigger 27 is provided to the front of the handle.

Cartridge holder 15 comprises an elongated open topped cradle having stop plates 17 and 19 to the opposite ends of the cradle. The front stop plate 19 includes an opening 21 to accommodate the nozzle 9 on the caulking cartridge.

A slotted opening 16 extends axially along the bottom of cradle 15.

A plunger 31 is contained within and slideable lengthwise of holder 15. The plunger has a cylindrical front face 32 which is a slightly smaller version of the cap 8 within the cartridge body 5.

Also contained within the rigid frame 13 is an endless drive belt 33. This drive belt has an extended belt section lying directly below and aligned with the slotted opening 16 in the cartridge holder.

Drive belt 33 wraps around a pair of idler rollers or pulleys 35 within the frame below the opposite ends of the cartridge holder. A further part of the drive belt drops down into the handle of the frame and wraps around a drive pulley 37. This drive pulley is wired to an electrical motor 39 contained within the motor housing part 25 of the frame. Trigger 27 is also wired to the electrical motor for operating the motor and the drive pulley 37.

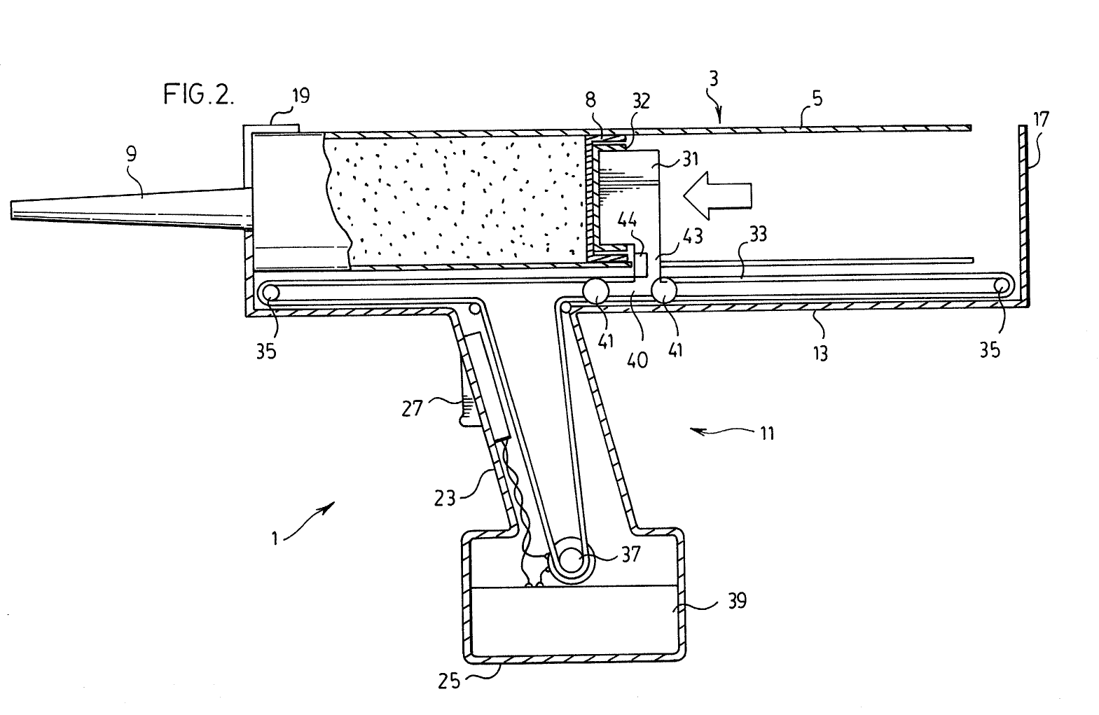

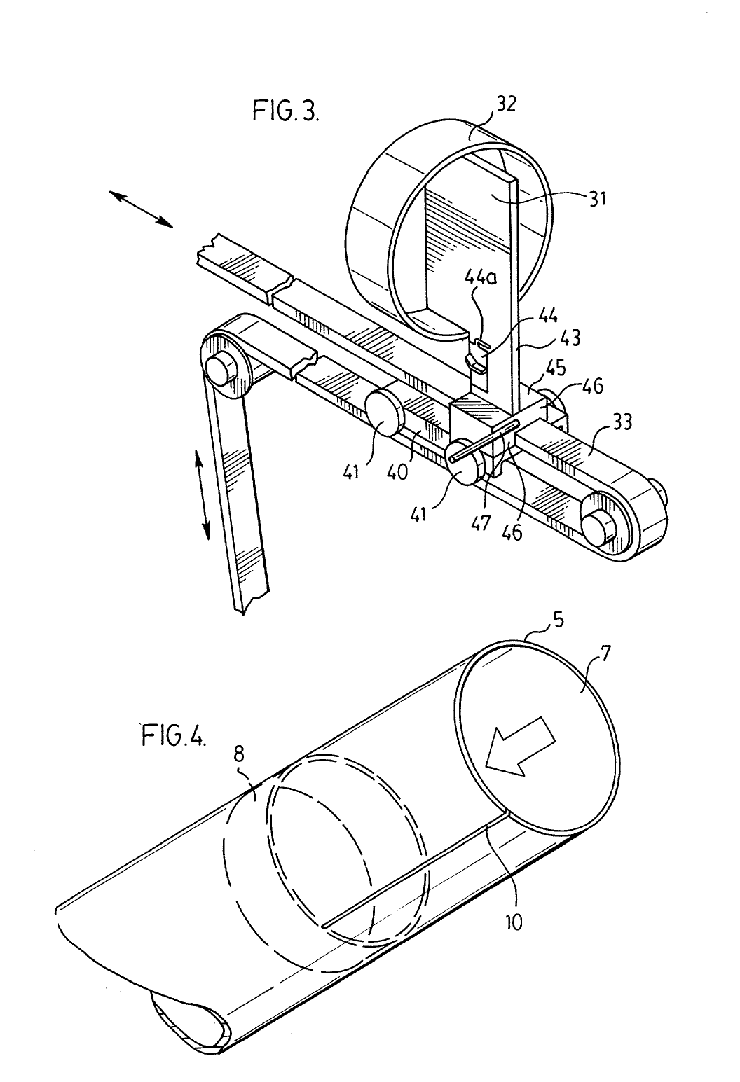

Referring now to FIGS. 2 and 3, it will be seen that plunger 31 is connected to drive belt 33 by a leg portion 43 and an adjustable clamp body 45 at the bottom end of the plunger.

Leg 43 extends through the slotted opening 16 in the cartridge holder while the clamp body 45 wraps around the drive belt 33.

The clamp body 45 is formed from a pair of body sections 46 and a quick connect, disconnect lever 47 which is used to adjust the body between a clamping and a non-clamping position. When in the clamping position, clamp body 45 is positively secured to the drive belt and when in the non-clamping position, body 45 is slideable along the drive belt.

Plunger 31 further includes a lower carriage 40, having rollers 41 which travel along the rigid frame 13 for guiding movement of the plunger. The wheels 41 are wider than and set to either side of drive belt 13 so that they do not interfere with operation of the drive belt. In addition, as can be seen in FIG. 1, the handle part 23 of the frame is slightly narrower than the upper frame part 13 which leaves a small side rail 14 over the complete length of the frame to its opposite sides, allowing the rollers 41 on the carriage 40 to ride over the handle part of the frame.

It should be noted that the rollers of the carriage can easily be replaced by sliders which are guided along the length of the frame. Such sliders would for example be made of plastic slideable within plastic tracks which would be extremely easy to manufacture and which would be essentially maintenance fee.

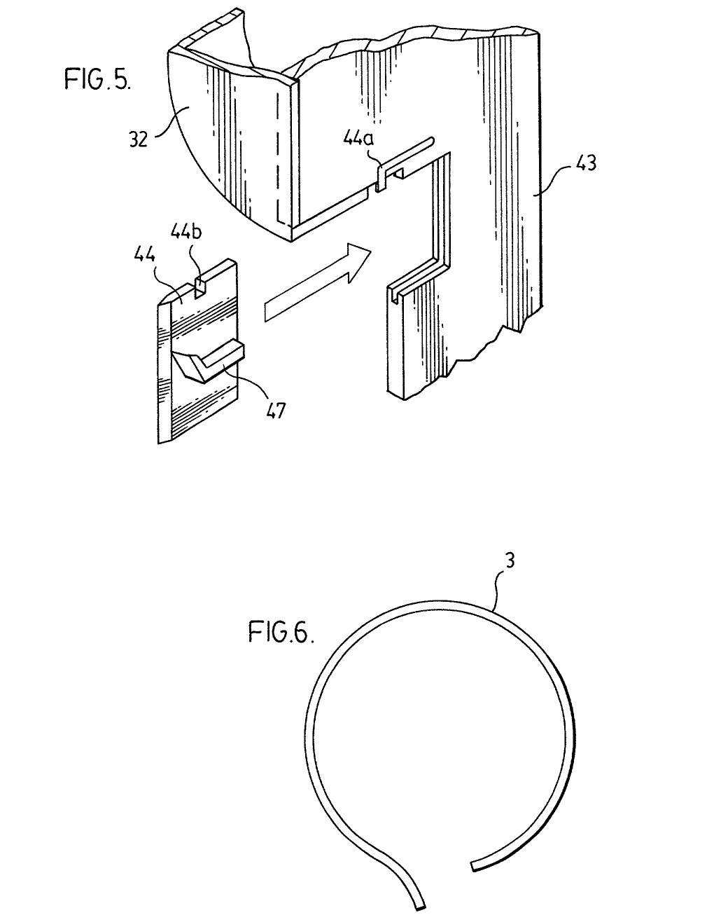

FIG. 5 shows that the drive transfer leg 43 of the plunger is fitted at its front side with a cutting blade 44. Provided on one side of the cutting blade is a cartridge wall deflector 47. This cutter and deflector combination cuts and deforms the cartridge as shown in FIG. 6.

Cutting blade 44 is easily replaceable on the movement transfer member 43. The movement transfer member includes a small moveable locking arm 44a which is spring biased to drop into a slot 44b to releasably secure the cutting blade in position. Obviously other locking arrangements can be used.

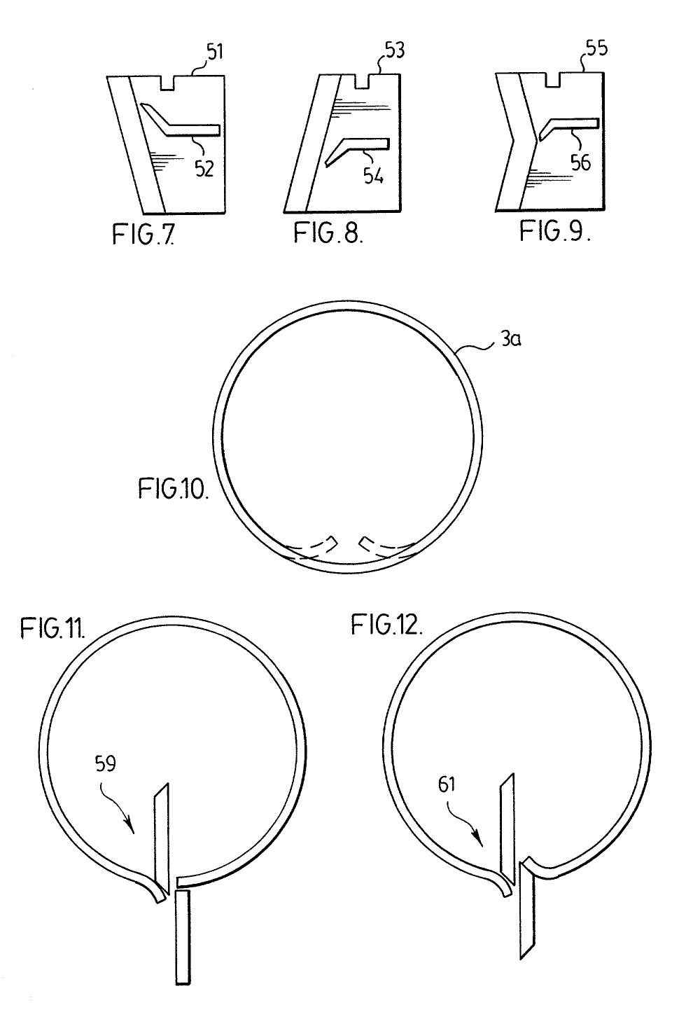

FIGS. 7 through 9 show various different shapes of cutting blades 51, 53 and 55 which could just as easily be used in replacement of cutting blade 45. In addition, cutting blades 53 and 55 have deflectors 54 and 56 respectively, with a down-turned forward nose as opposed to the up-turned forward nose of the deflectors 47 and 52 on blades 45 and 51 respectively.

It is to be appreciated that various different shapes of cutting blades over and above those shown in the drawings, can be used on the plunger and further that deflectors can be provided to both sides of the cutting blade as opposed to only one side of the blade as is shown in the drawings.

As will be described later in detail, cutting blade 44 with its deflector 47, produces a cutting and deflecting or bending action on the cartridge body as shown in FIG. 6 of the drawings. FIG. 10 of the drawings shows a cartridge 3a as it would be cut and bent using either one of the cutters 53 or 55 but having deflectors to both sides of the cutters.

FIGS. 11 and 12 of the drawings show rotating cutting wheels 59 and 61 that can be used with the plunger. In FIG. 11 the cutting wheels have deflection to one side only whereas in FIG. 12 the wheels have deflection to both sides of the cartridge.

Based on FIGS. 5 through 12 of the drawings, it is to be understood that all sorts of cutting and deflecting combinations can be used with the cartridge plunger.

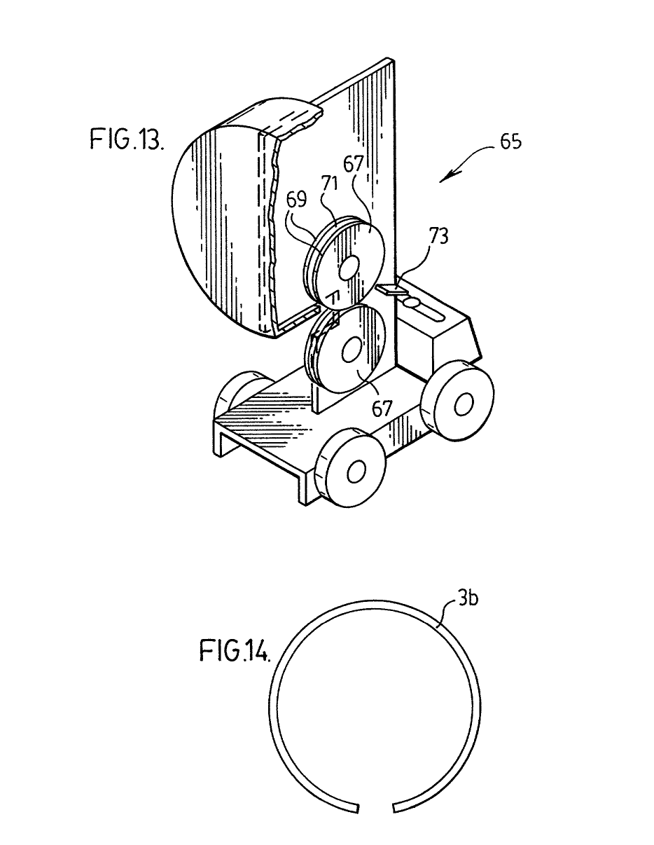

FIGS. 13 and 14 of the drawings show a slightly different cutting action that can be performed by the plunger on the cartridge body. More particularly, a plunger 65 which is substantially the same as the earlier described plunger 31, is provided with a pair of cutting wheels 67. Each of these wheels has a pair of cutting edges 69 separated by a centre groove 71 in the wheel.

The cutting arrangement shown in FIG. 13 produces a cutting action on a cartridge body 3b as shown in FIG. 14. According to this cutting action, part of the cartridge body is actually removed as a strip of material 73, shown in FIG. 13. This allows the plunger to pass through without having to deflect the cartridge body.

Operation of the system of FIG. 1 will be described having best reference to FIG. 2 of the drawings. In this figure it will be seen that cartridge 3 is loaded into the cradle-like cartridge holder of the caulking gun where the plunger 31 is able to enter the open rear end 7 of the body of the cartridge.

The gun is operated by pressing trigger 27 to turn on motor 39. This produces a rotation of drive pulley 37 causing movement of drive belt 33. When the clamp body 45 of the plunger is in its clamped or belt engaged position, the movement of the drive belt is transferred through leg 43 to the plunger. The plunger which rides on its carriage 40, moves forward into the open rear end of the cartridge.

One of the key features to the present invention resides in the fact that the plunger includes its own cutter, which allows the plunger to move forwardly along the cartridge body. Without this cutter the cartridge would prevent the forward movement of the plunger however, with the provision of the cutter the leg portion 43 of the plunger, which travels along the slotted opening 16 at the bottom of the cartridge holder, produces a cutting action on the cartridge as shown in FIG. 4 of the drawings. This cutting action results in an elongated slit 10, which provides a passage for the plunger leg 43 through the cartridge body. Further provided on the cutter is any one of the deflectors shown in FIGS. 5 and 7 through 9 of the drawings which deflect the edge or edges of the cartridge to produce a wider opening of slit 10, giving greater clearance for the passage of the plunger along the length of the cartridge body.

As the plunger moves forward it pushes on and slides cap 8 forwardly in the cartridge. This results in a dispensing of the caulking material through the forward nozzle 9 of the cartridge.

The speed at which motor 39 rotates pulley 37 is dependent upon the degree to which trigger 27 is depressed. This is the same as the operation of most presently available rotary hand drills. Accordingly, the dispensing system of FIG. 1 is able to be controlled very accurately for either the very slow dispensing of relatively small amounts of caulking material or for much more rapid dispensing of larger amounts of caulking material depending upon the speed of operation of motor 39 through the positioning of trigger 27.

Once the cartridge has been fully emptied to be replaced with another cartridge, the user simply disengages clamp body 45 from drive belt 33 through the use of lever 47. This allows the plunger to be rolled rearwardly along the cartridge holder independently of the drive belt until the plunger clears the cartridge, allowing the cartridge to be removed from the cartridge holder. At this point the plunger is then re-clamped with the drive belt ready for dispensing caulking material from a filled replacement cartridge.

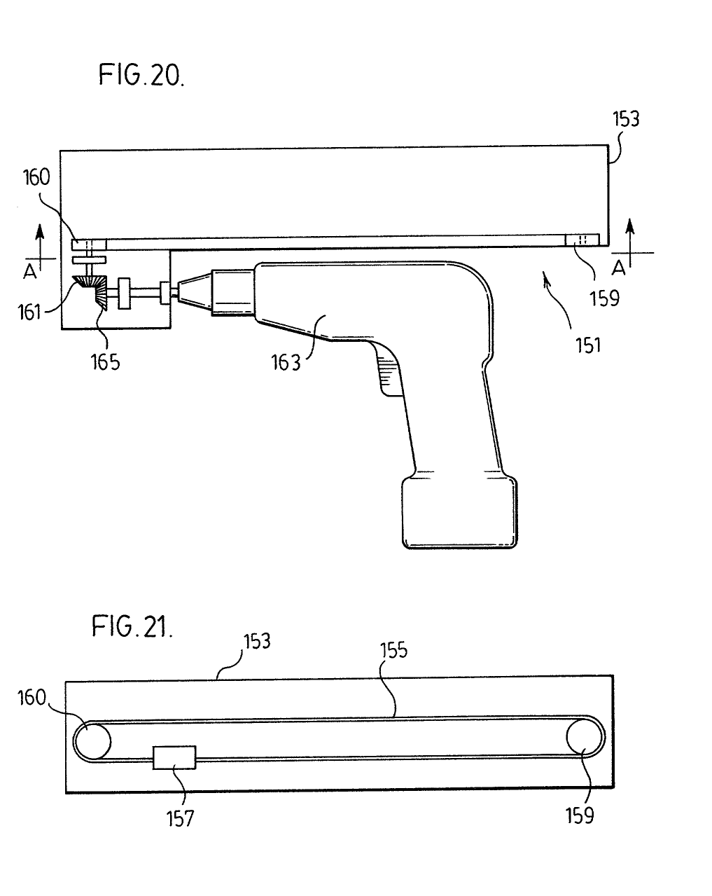

FIG. 20 shows a caulking gun assembly generally indicated at 151 which is belt and pulley operated in a slightly different manner. In this particular case the drive belt 155 is an endless belt directly below the cartridge holder 153. This endless belt wraps around a passive pulley 159 and an active or drive pulley 160.

This particular gun assembly is operated by a hand drill 163 removably fitted with the assembly. The shaft of the hand drill is fitted with a bevel gear 165. The bevel gear meshes with a further level gear 161 journelled to the drive pulley 160.

A motion transfer member 157 is releasably engaged with the belt 155.

In this assembly the drive belt lies in a single plane, takes up very little space and is light in weight. Furthermore, this assembly is very conducive for use with a hand drill as described above.

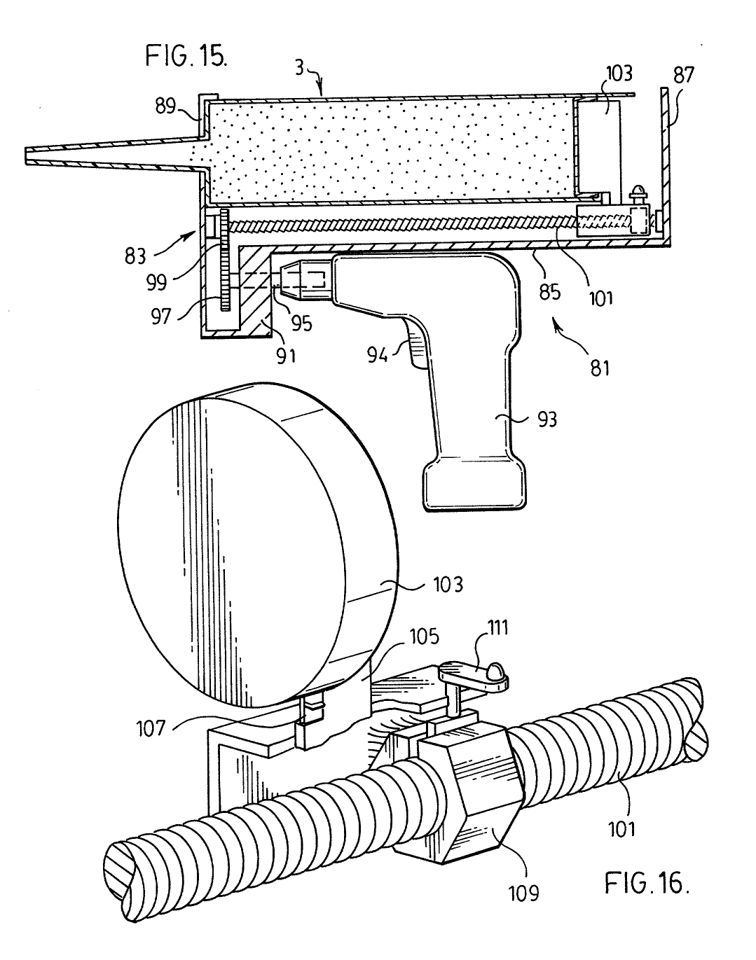

FIGS. 15 and 16 show a caulking dispensing system similar in concept but different in construction from that which has been described above.

More particularly, FIG. 15 shows a caulking dispensing system generally indicated at 81. This system uses the same caulking cartridge generally indicated at 3 but a modified dispensing assembly generally indicated at 83. This dispensing assembly again includes a rigid frame 85 having an upper cartridge holder defined at its opposite ends by support plates 87 and 89.

The frame further includes a lower frame part 91 which rather than being a handle for the frame, comprises an adapter for receiving a rotary hand drill 93. In this embodiment, like the embodiment of FIG. 20, the hand drill forms the actual handle for the assembly.

The bit 95 of the hand drill is fitted with a gear 97. This gear meshes with a further gear 99 of the assembly. Gear 99 is secured to one end of a typically threaded shaft 101 held within the frame 85 directly below the slotted opening in the cartridge holder. This slotted opening is the same as slotted opening 16 shown in FIG. 1 of the drawings.

Shaft 101 is a hollow tube which helps to reduce the overall weight of the assembly to ease handling by the operator.

Assembly 81 further includes a plunger 103 moveable within the cartridge holder. This plunger includes a leg 105, which extends through the slotted opening in the cartridge holder and which is provided with a forwardly facing cartridge cutter 107.

Plunger 103 is releasably connected to threaded shaft 101 by means of a clamp body 109. Clamp body 109 is internally threaded to fit with and thread along shaft 101. A quick connect, disconnect lever 111 is provided for clamping and unclamping body 109 relative to shaft 101 to produce either a shaft engaging or a shaft releasing condition of the plunger relative to the drive shaft.

Operation of the dispensing system is produced by turning on the drill 93 through its trigger 94 to rotate drill bit 95 and gear 97 secured to the drill bit. Gear 97 meshes with and rotates gear 99 to produce a rotation of drive shaft 101. When clamp body 109 is in its clamped or drive shaft engaged condition, the rotation of the drive shaft causes the plunger to thread forwardly along the cartridge holder of the frame. Cutter 107 cuts and deflects the body of the cartridge while the plunger 103 pushes on and dispenses the material from the caulking cartridge.

Through the use of quick connect, disconnect lever 111, clamp body 109 can be opened sufficiently to clear its internal threads from the external threads of the drive shaft to allow the plunger to be slid to the rear of the cartridge holder for removing a used cartridge and replacing it with a refill cartridge. The clamp can then be re-tightened to engage the plunger with the drive shaft, ready for further dispensing operation.

In both of the above embodiments it is to be noted that the hand control is positioned centrally of the gun with very little weight shift along the length of the gun as it is being used. This makes handling of the gun very easy.

Furthermore in either embodiment power can be provided by on board batteries or by an AC outlet to which the gun is connected by an electrical cord.

In a standard caulking gun it is difficult to immediately relieve pressure on the cartridge. Without this pressure relief excess material is pushed from the cartridge.

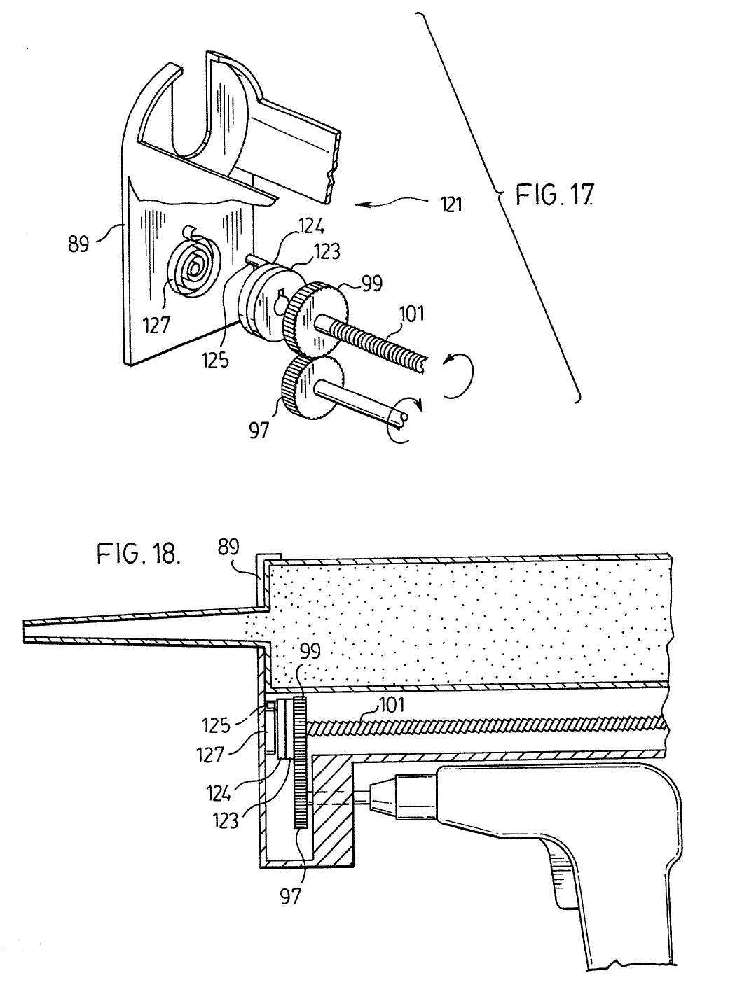

FIGS. 17 through 19 show features of the invention which are directed to this problem.

FIG. 17 shows a cartridge pressure relief assembly generally indicated at 121. This assembly fits with assembly 81 of FIG. 15.

Assembly 121 comprise a first friction disc 123 which is keyed onto shaft 101 against the front face of gear 99. Disc 123 frictionally engages a second friction disc 124 which is rotatably mounted on the shaft and which includes a pin 125 hooked into a coil spring 127 secured to cartridge holder 89.

Disc 123 is rotated by shaft 101. Disc 123 drives disc 124 because of the frictional engagement of the two discs. This produces a winding or tightening of spring 127 due to the engagement of pin 125 of disc 124 with the spring.

The spring winds sufficiently to overcome the friction engagement of the two discs. At this point the gun continues to dispense the caulking material but does not continue to wind the spring. However there is still sufficient frictional resistance between the discs to prevent the second disc and the spring from unwinding relative to the first disc.

As soon as the gun is turned off the tension of the wound spring and the engagement of the second disc 124 with the first disc 123 turns the otherwise idle shaft in the reverse direction. This pulls the plunger away from the back of the cartridge to immediately release pressure on the cartridge and prevent excess material dispensing.

According to another aspect of the invention a clutch provided at the gears for driving the assembly engaged through a clutch drive with the drill. This clutch drive engages to ensure that the gears are rotated in the forward dispensing direction. However the clutch immediately releases when the drill is shut off so that the pressure relief system reverses shaft 101 without having to turn the drill motor. This reduces pressure on the system and requires less battery use.

It is to be understood that a similar pressure relief assembly can easily be provided with the gun of FIG. 1. In this setup the friction discs and spring are operated from the drive pulley 37 to reverse the movement of the plunger when the gun is turned off.

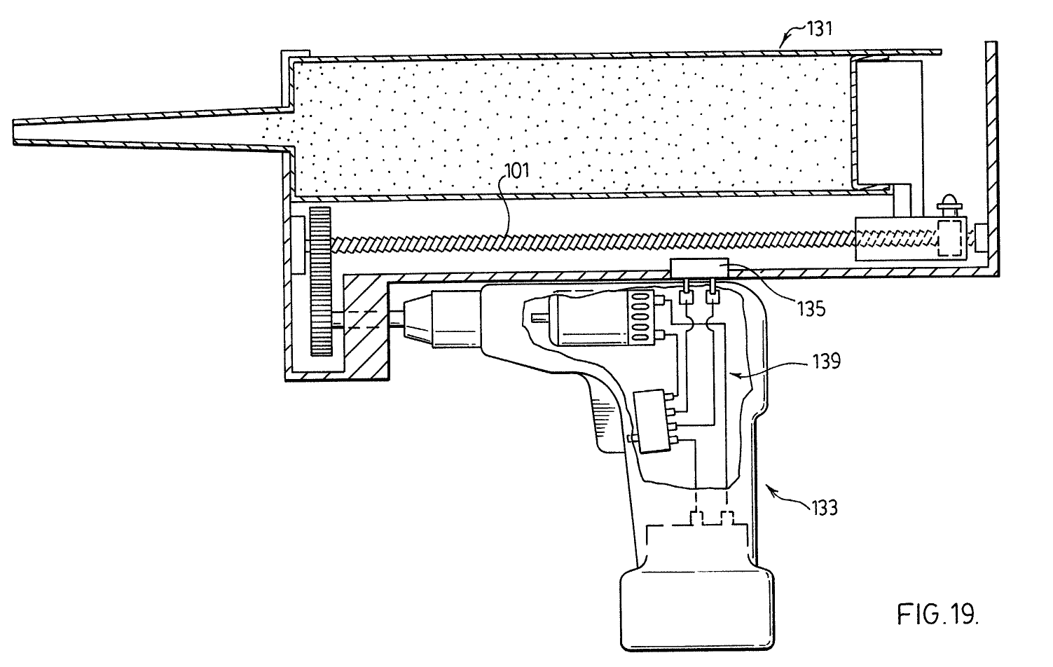

FIG. 19 shows a caulking gun assembly 131 very similar to what is shown in FIG. 15 except that hand drill 93 is replaced by a customized hand drill 133 in FIG. 19. In all other aspects the assemblies are identical.

Drill 133 includes a small shaft reverser 135.

This shaft reverser does not affect forward movement of the plunger whatsoever. However, the shaft reverser, which can be in the form of a transducer or the like, is given a charge build-up through an electrical circuit generally indicated at 139 when the hand drill is operating. As soon as the drill is turned off the gear reverser discharges to operate the drill in the reverse direction pulling the plunger away from the back of the cartridge.

The operation of the shaft reverser is essentially instantaneous to immediately relieve plunger pressure. However, it is also very short in duration due to the provision of a timer built into circuit 139 so that the plunger is not pulled very far from away from the cartridge.

The drill as shown connects directly to the system for the motor reversing. The motor reverser would not work away from the assembly. In another embodiment the drill may be provided with a separate control switch to turn off the motor reverser for standard uses of the drill away from the caulking gun.

According to another aspect of the invention a clutch provided at the gears for driving the assembly engaged through a clutch drive with the drill. This clutch drive engages to ensure that the gears are rotated in the forward dispensing direction. However the clutch immediately releases when the drill is shut off so that the pressure relief system reverses shaft 101 without having to turn the drill motor. This reduces pressure on the system and requires less battery use.

The description above relates to the use of a solid, e.g.. board material, caulking cartridge. The present invention also contemplates a caulking gun assembly adapted to receive a softer type of caulking cartridge known in the industry as a sausage cartridge. This sausage cartridge comprises a very lightweight skin containing the caulking material.

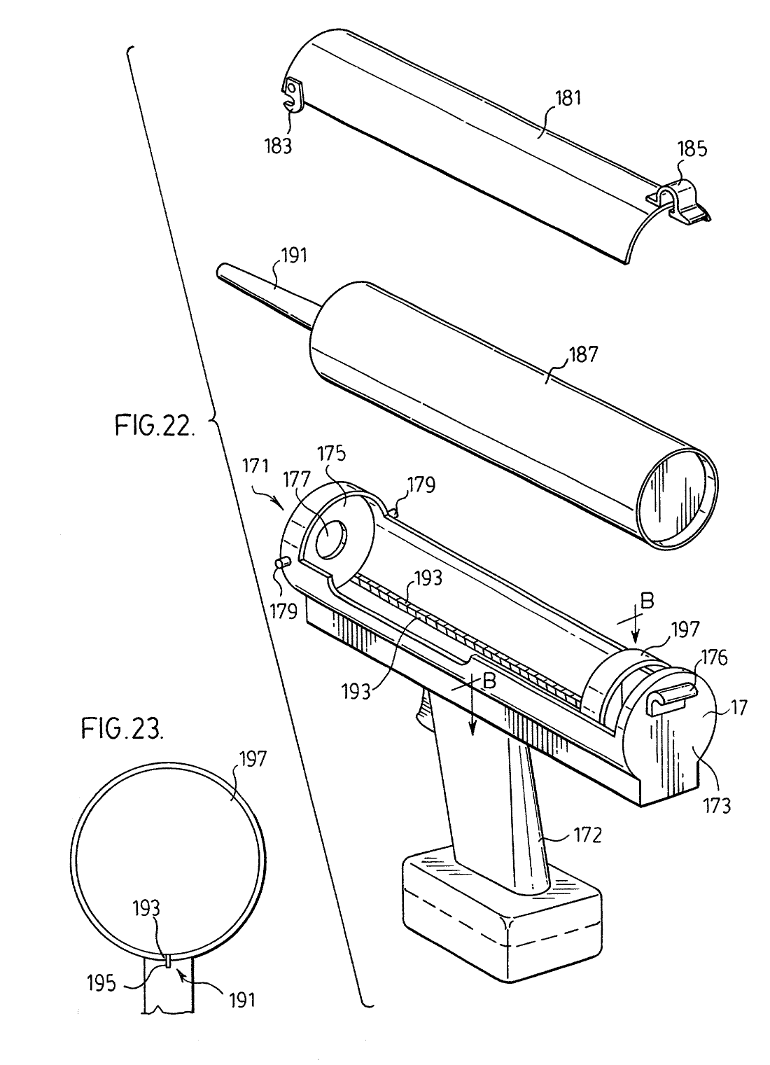

FIG. 22 shows a modified caulking gun assembly generally indicated at 171 for use with a sausage cartridge. This assembly includes a motor containing handle 172 with a rigid cartridge holder 173 atop the handle. Holder 173 includes a rear plate 174 and a front plate 175. Plate 174 includes a catch 176 and plate 175 includes a pair of pins 179.

A sausage type cartridge 187 having a front nozzle 191 locates within the cartridge holder. Since this cartridge is very soft walled it needs to be completely surrounded by rigid support. Accordingly a holder top closure 181 is provided. This closure includes hinges 183 which fit onto the pins 179 at the front of the holder to provide a hinged connection between the main body of the holder and its top closure. The closure includes a clip 185 which secures with catch 176 to lock the closure in position after inserting the cartridge.

Note that the front plate 175 includes a nozzle hole 177 through the plate. This is different from the slot in the earlier embodiments. This nozzle hole traps the front end of the sausage in place within the holder. This same hole can also be used in lieu of the nozzle slot for the earlier described rigid cartridge applications.

The cartridge holder has a bottom slot generally indicated at 191 in FIG. 23. Like the earlier embodiments slot 191 extends the length of the holder directly above the drive member which can be any one of the earlier described drive members.

Again for adapting the caulking gun assembly for the softer cartridge the slot is closed or at least substantially closed by a pair of flexible strips 193 which attach to the edges of the slot. These strips which may for example be made from a rubber or plastic material are only rigid enough to prevent the skin of the sausage from squeezing down into the slot. They act as caulking material blocks in the event of rupturing of the skin. This prevents the caulking material from penetrating to the motor controls of the assembly should there be a skin failure.

The flexibility of the strips 193 allows the drive transfer member 195 to fit through the slot from the drive member (not shown) to the plunger. The drive transfer member only produces a localized opening of slot so that the slot remains closed or essentially closed other than at the location of the drive transfer member.

The flexibility of the strips allows the drive transfer member to travel along the slot.

In this set up even though the cutter may be provided on the drive transfer member the cutter is not required for operation since the cartridge, due to its soft thin wall will collapse and fold in front of the plunger.

Although various preferred embodiments of the invention have been described in detail, it will be appreciated by those skilled in the art that variations may be made without departing from the spirit of the invention or the scope of the appended claims.

The embodiments of the invention in which an exclusive property or privilege is claimed are defined as follows:

1. A caulking cartridge dispensing assembly comprising a rigid frame having a cartridge holder with a slotted opening axially of the cartridge holder, an electrically operated drive member extending lengthwise of said frame aligned with said slotted opening of said cartridge holder, a plunger, a drive transfer member which fits through said slotted opening between said drive member and said plunger, said drive transfer member being adjustable between a drive member engaged condition and a drive member released condition, said plunger being connected with and moveable along the frame by said drive member when the drive transfer member is in the engaged condition and said plunger being slideable relative to both said drive member and said rigid frame when said drive transfer member is in the released condition.

2. A caulking cartridge dispensing assembly as claimed in claim 1 including a manually operated quick release clamp that adjusts said drive transfer member between the drive member engaged and released positions.

3. A caulking cartridge dispensing assembly as claimed in claim 1 wherein said drive member comprises a rotatable shaft with a helically threaded exterior surface and said drive transfer member comprises a quick release clamp with a threaded interior surface fitted over said exterior surface of said rotatable shaft.

4. A caulking cartridge dispensing assembly as claimed in claim 1 wherein said drive member comprises an endless belt wrapped around a drive pulley and said drive transfer member comprises a clamp releasably clamped onto said endless belt.

5. A caulking cartridge dispensing assembly as claimed in claim 1 wherein said rigid frame includes a handle containing an electric motor for operating said drive member.

6. A caulking cartridge dispensing assembly as claimed in claim 1 wherein said frame includes an adapter to receive a rotary hand drill for operating said dispensing assembly.

7. A caulking cartridge dispensing assembly as claimed in claim 1 wherein said drive transfer member is provided with a cartridge cutter.

8. A caulking cartridge dispensing assembly as claimed in claim 7 wherein said cartridge cutter includes a cartridge wall deflector.

9. A caulking cartridge dispensing assembly as claimed in claim 7 wherein said cartridge cutter comprises a grooved wheel with spaced apart cutting edges on said wheel.

10. A caulking cartridge dispensing assembly as claimed in claim 1 wherein said assembly includes a handle for holding said assembly, said handle being located generally centrally of said assembly below said cartridge holder.

11. A caulking dispensing assembly as claimed in claim 1 wherein said assembly is operated by an on board battery power supply.

12. A caulking cartridge dispensing assembly as claimed in claim 1 wherein said assembly is operated by a remote AC power supply.

13. A caulking cartridge dispensing assembly as claimed in claim 1 including a plunger pressure relief system which acts to move the plunger rearwardly on the assembly with shut down of said electrically operated drive member.

14. A caulking cartridge dispensing assembly as claimed in claim 13 wherein said plunger pressure relief system comprises a clutch frictionally engaged with said drive member and a coil spring wound by said clutch as said drive member is operated, said coil spring reversing direction of movement of said drive member following operation of said drive member.

15. A caulking cartridge dispensing assembly as claimed in claim 13 wherein said frame is fitted with a rotary hand drill to operate said assembly and wherein said plunger pressure relief system comprises a drive member reverser which is electrically charged by and is inactive during operation of said hand drill, said plunger pressure relief system operating after shut down of said electrically operated drive member to move said plunger rearwardly along said frame.

16. A caulking cartridge dispensing assembly as claimed in claim 1 wherein said drive member comprises on endless belt looped around a drive pulley and another pulley at opposite ends of said frame directly below said cartridge holder.

17. A caulking dispensing assembly as claimed in claim 16 wherein said assembly is powered by a hand drill fitted with said assembly, said assembly including meshing gears rotated by said hand drill, one of said gears being coupled with and providing a drive for said drive pulley.

18. A caulking cartridge dispensing assembly as claimed in claim 17 wherein said meshing gears comprise bevel gears.

19. A caulking cartridge dispensing assembly as claimed in claim 1 wherein said assembly is usable with a soft cartridge and wherein said cartridge holder comprises a full enclosure with a releasably lockable top closure member, said slot being fitted with flexible slot closing means and said drive transfer member pushing through said flexible slot closing means from said drive member to said plunger.

20. A caulking cartridge dispensing assembly as claimed in claim 19 wherein said flexible slot closing means comprises flexible strips secured to said cartridge holder on opposite sides of said slot.
